(19) United States
(12) Patent Application Publication
(10) Pub. No.: US 2025/0387907 A1
(43) Pub. Date: Dec. 25, 2025

(54) TECHNIQUES FOR CONTROLLING FORCE IN TELEOPERATED INSTRUMENTS

(71) Applicant: INTUITIVE SURGICAL OPERATIONS, INC., Sunnyvale, CA (US)

(72) Inventor: Mathew P. NUSSBAUM, Campbell, CA (US)

(21) Appl. No.: 19/248,359

(22) Filed: Jun. 24, 2025

Related U.S. Application Data
(60) Provisional application No. 63/663,977, filed on Jun. 25, 2024.
(60) Provisional application No. 63/689,481, filed on Aug. 30, 2024.

(51) Int. Cl. B25J 9/16; B25J 13/02; B25J 13/08

(52) U.S. Cl. CPC B25J 9/1633; B25J 9/1674; B25J 9/1689; B25J 9/1697; B25J 13/025; B25J 13/085

(57) ABSTRACT

Techniques for controlling force in teleoperated instruments include a repositionable structure configured to support an instrument, an input control, and a control system. The control system is configured to control the instrument based on input received from an operator using the input control; during the control of the instrument in a first mode, determine whether to switch control of the instrument to a second mode; in response to a determination to switch the control of the instrument to the second mode, switch control of the instrument to the second mode; and while in the second mode, actuate an actuator used to control the instrument subject to a second force or torque limit lower than a first force or torque limit used to actuate the actuator in the first mode. Controlling the instrument includes controlling one or both of a position or an orientation of the instrument.

### CROSS-REFERENCE TO RELATED APPLICATIONS

This application claims benefit of the United States Provisional Patent Application titled “TECHNIQUES FOR CONTROLLING FORCE IN TELEOPERATED INSTRUMENTS,” filed Aug. 30, 2024, and having Ser. No. 63/689,481 and claims benefit of the United States Provisional Patent Application titled “TECHNIQUES FOR CONTROLLING FORCE IN TELEOPERATED INSTRUMENTS”, filed Jun. 25, 2024, and having Ser. No. 63/663,977. The subject matter of these related applications is hereby incorporated herein by reference.

### BACKGROUND

### Field of the Various Embodiments

Embodiments of the present disclosure relate generally to operation of devices with repositionable structures and end effectors and more particularly to operation of teleoperated instruments with variable force control.

### DESCRIPTION OF THE RELATED ART

The landscape of teleoperated and medical technology is rapidly evolving, with a significant shift towards the integration of autonomous and semi-autonomous electronic devices within various settings. For example, in medical applications, the shift is particularly evident in environments, such as operating rooms, interventional suites, and intensive care units. Conventional medical tools and methodologies are increasingly being supplemented or replaced by sophisticated computer-assisted devices. For example, the replacement of manual thermometers with electronic variants, the incorporation of electronic monitors into intravenous drip systems, and the transition from hand-held surgical instruments to computer-assisted surgical systems to name a few.

Minimally invasive surgery (MIS) epitomizes the advancement in medical procedures, aiming to reduce the trauma inflicted on healthy tissues during interventions. MIS procedures are predominantly facilitated by computer-assisted devices, which allow surgeons to remotely operate surgical instruments with high precision. The interface between the surgeon and the instrument is mediated through advanced control systems, translating the surgeon's inputs into precise movements of surgical end effectors at the patient's site, which is often referred to as teleoperation. Teleoperation, supplemented by semi-autonomous control capabilities, enables the performance of complex surgical tasks with minimal physical intrusion.

Conventional methods for controlling teleoperated instruments, such as surgical instruments in minimally invasive surgery, typically involve direct manual operation or teleoperated systems, where an operator uses physical controls or interfaces to dictate the movement and actions of the instruments. In manual operation, operators directly manipulate the instruments through access sites, such as incisions, using skill and experience to judge the appropriate amount of force and movement required. Teleoperated systems, on the other hand, extend the operator's capabilities to control instruments remotely. Teleoperated systems typically feature a console where the operator manipulates input controls that translate the operator's movements into precise actions of manipulator arms and attached instruments. Examples of such teleoperated systems include platforms such as the da Vinci Surgical System provided by Intuitive Surgical of Sunnyvale, California, where the operator's hand movements are scaled down and translated into finer motions by the instruments, enabling a high degree of precision within the surgical site.

One drawback of conventional methods for controlling instruments as well as surgical instruments is that conventional methods are often rigid and lack responsiveness to the complex and dynamic nature of various procedures.

As the foregoing indicates, what is needed in the art are more effective techniques for controlling force or torque in surgical instruments.

### SUMMARY

Consistent with some embodiments, a computer-assisted system includes a repositionable structure configured to support an instrument, an input control, and, a control system. The control system is configured to control the instrument based on input received from an operator using the input control. Controlling the instrument includes controlling one or both of a position or an orientation of the instrument. During the control of the instrument in a first mode, the control system is configured to determine whether to switch control of the instrument to a second mode. While in the first mode, an actuator used to control the instrument is actuated subject to a first force or torque limit. In response to a determination to switch the control of the instrument to the second mode, the control system is further configured to switch control of the instrument to the second mode. While in the second mode, an actuator used to control the instrument is actuated subject to a second force or torque limit different than the first force or torque limit.

Consistent with some embodiments, a method for controlling an instrument includes controlling, by a control system, an instrument supported by a repositionable structure based on input received from an operator using an input control, wherein controlling the instrument comprises controlling one or both of a position or an orientation of the instrument; during the controlling of the instrument in a first mode, determining, by the control system, whether to switch to controlling the instrument to a second mode, wherein while in the first mode, an actuator used to control the instrument is actuated subject to a first force or torque limit; in response to determining to switch the controlling of the instrument in the second mode, switching, by the control system, controlling of the instrument in the second mode; and while in the second mode, actuating, by the control system, the actuator subject to a second force or torque limit different than the first force or torque limit.

Consistent with some embodiments, one or more non-transitory machine-readable media include a plurality of machine-readable instructions which when executed by one or more processors are adapted to cause the one or more processors to perform any of the methods described herein.

The foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a simplified diagram of a computer-assisted system configured to implement one or more aspects of the present embodiments;

FIG. 2 is a simplified diagram showing an instrument, according to some embodiments;

FIG. 3 illustrates an example of a circular stapler, according to various embodiments;

FIG. 4 illustrates an example of a needle driver, according to various embodiments;

FIG. 5 illustrates an example of a uterine manipulator, according to various embodiments;

FIG. 6 illustrates the control application of FIG. 1 in more detail, according to various embodiments; and

FIG. 7 is a flow diagram of method steps for controlling force and/or torque limits of an instrument or the repositionable structure supporting the instrument, according to various embodiments.

### DETAILED DESCRIPTION

This description and the accompanying drawings that illustrate inventive aspects, embodiments, embodiments, or modules should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail in order not to obscure the invention. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Further, the terminology in this description is not intended to limit the invention. For example, spatially relative terms-such as “beneath”, “below”, “lower”, “above”, “upper”, “proximal”, “distal”, and the like-may be used to describe one element's or feature's relationship to another element or feature as illustrated in the figures. These spatially relative terms are intended to encompass different positions (i.e., locations) and orientations (i.e., rotational placements) of the elements or their operation in addition to the position and orientation shown in the figures. For example, if the content of one of the figures is turned over, elements described as “below” or “beneath” other elements or features would then be “above” or “over” the other elements or features. Likewise, descriptions of movement along and around various axes include various special element positions and orientations. In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components.

Elements described in detail with reference to one embodiment, embodiment, or module may, whenever practical, be included in other embodiments, embodiments, or modules in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, embodiment, or application may be incorporated into other embodiments, embodiments, or aspects unless specifically described otherwise, unless the one or more elements would make an embodiment or embodiment non-functional, or unless two or more of the elements provide conflicting functions.

In some instances, well known methods, procedures, components, and circuits have not been described in detail so as not to unnecessarily obscure aspects of the embodiments.

This disclosure describes various elements (such as systems and devices, and portions of systems and devices) with examples in three-dimensional space. In such examples, the term “position” refers to the location of an element or a portion of an element in a three-dimensional space (e.g., three degrees of translational freedom along Cartesian x-, y-, and z-coordinates). Also in such examples, the term “orientation” refers to the rotational placement of an element or a portion of an element (three degrees of rotational freedom—e.g., roll, pitch, and yaw). Other examples may encompass other dimensional spaces, such as two-dimensional spaces. As used herein, the term “pose” refers to the position, the orientation, or the position and the orientation combined, of an element or a portion of an element. As used herein, and for an element or portion of an element, e.g. a device (e.g., a computer-assisted device or a repositionable arm), the term “proximal” for elements in a kinematic chain refers to a direction toward the base of the kinematic chain, and the term “distal” refers to a direction away from the base along the kinematic chain.

Aspects of this disclosure are described in reference to electronic systems and computer-assisted devices, which may include systems and devices that are teleoperated, remote-controlled, autonomous, semiautonomous, robotic, and/or the like. Further, aspects of this disclosure are described in terms of an embodiment using a medical system, such as the da Vinci® Surgical System commercialized by Intuitive Surgical, Inc. of Sunnyvale, California. Knowledgeable persons will understand, however, that inventive aspects disclosed herein may be embodied and implemented in various ways, including robotic and, if applicable, non-robotic embodiments. Embodiments described for da Vinci® Surgical Systems are merely exemplary, and are not to be considered as limiting the scope of the inventive aspects disclosed herein. For example, techniques described with reference to surgical instruments and surgical methods may be used in other contexts. Thus, the instruments, systems, and methods described herein may be used for humans, animals, portions of human or animal anatomy, industrial systems, general robotic, or teleoperational systems. As further examples, the instruments, systems, and methods described herein may be used for non-medical purposes including industrial uses, general robotic uses, sensing or manipulating non-tissue work pieces, cosmetic improvements, imaging of human or animal anatomy, gathering data from human or animal anatomy, setting up or taking down systems, training medical or non-medical personnel, and/or the like. Additional example applications include use for procedures on tissue removed from human or animal anatomies (with or without return to a human or animal anatomy) and for procedures on human or animal cadavers. Further, these techniques can also be used for medical treatment or diagnosis procedures that include, or do not include, surgical aspects.

### System Overview

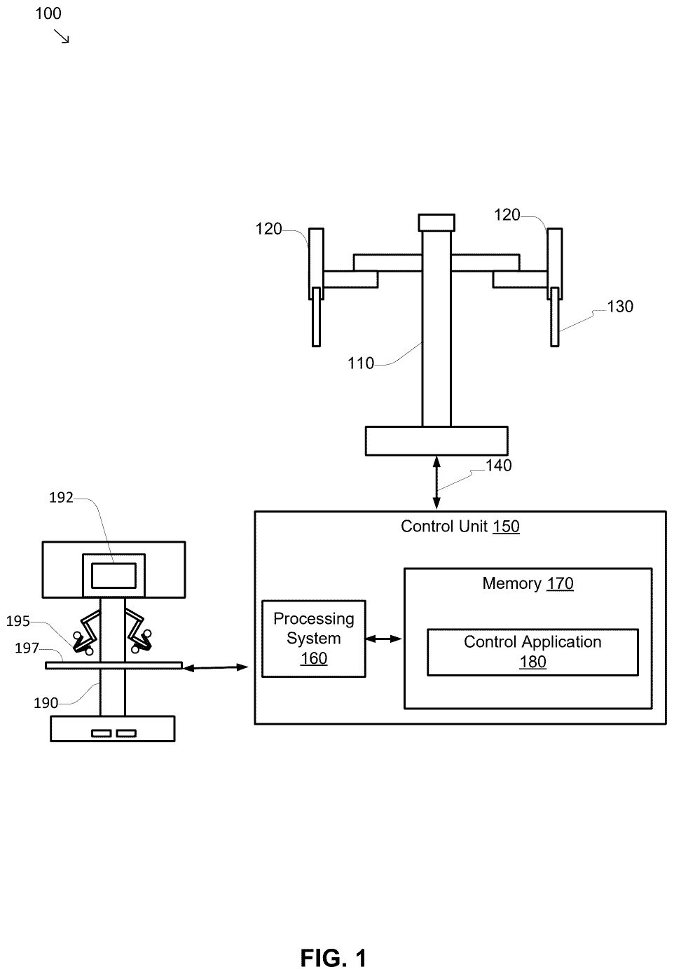

FIG. 1 is a simplified diagram of a computer-assisted system 100 according to some embodiments. As shown in FIG. 1, computer-assisted system 100 includes a computer-assisted device 110, e.g., computer-assisted device, with one or more movable or repositionable structures 120, which are sometimes referred to as manipulator arms. Each of the one or more repositionable structures 120 can support one or more instruments, e.g., instruments 130. In some examples, computer-assisted device 110 can be consistent with a computer-assisted surgical device. The one or more repositionable structures 120 can each provide support for instruments 130 such as, imaging devices, and/or the like. In some examples, the instruments 130 can include end effectors that are capable of, but are not limited to, performing, grasping, retracting, cauterizing, ablating, suturing, cutting, stapling, fusing, sealing, etc., and/or combinations thereof. In some examples, an imaging device can include an endoscopic camera.

Computer-assisted device 110 is coupled to a control unit 150 via an interface 140. The interface 140 can include one or more cables, fibers, connectors, and/or buses and can further include one or more networks with one or more network switching and/or routing devices. Control unit 150 includes a processor 160 coupled to memory 170. Operation of control unit 150 can be controlled by processor 160. And although control unit 150 is shown with only one processor 160, it is understood that processor 160 can be representative of one or more central processing units, multi-core processors, microprocessors, microcontrollers, digital signal processors, graphics processing units, field programmable gate arrays (FPGAs), application specific integrated circuits (ASICs), and/or the like in control unit 150. Control unit 150 can be implemented as a stand-alone subsystem and/or board added to a computing device or as a virtual machine. In some embodiments, control unit 150 can be included as part of the operator workstation and/or operated separately from, but in coordination with the operator workstation.

Memory 170 can be used to store software executed by control unit 150 and/or can include one or more data structures used during operation of control unit 150. Memory 170 can include one or more types of machine-readable media. Some common forms of machine readable media can include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

As shown in FIG. 1, memory 170 can include a control application 180 that can be used to support autonomous, semiautonomous, and/or teleoperated control of computer-assisted device 110. Control application 180 can include one or more application programming interfaces (APIs) for receiving position, motion, force, torque, and/or other sensor information from computer-assisted device 110, repositionable structures 120, and/or instruments 130, exchanging position, motion, force, torque, and/or collision avoidance information with other control units regarding other devices, and/or planning and/or assisting in the planning of motion for computer-assisted device 110, repositionable structures 120, and/or instruments 130. The control application 180 can receive the sensor information from computer-assisted device 110 through interface 140 and control unit 150 and can communicate control signals through interface 140 and control unit 150 to computer-assisted device 110. In some examples, control application 180 can further support autonomous, semiautonomous, and/or teleoperated control of the instruments 130 during a surgical procedure. And although control application 180 is depicted as a software application that can be executed on processor 160, control application 180 can be implemented using standalone hardware separate from the processor 160 or can be implemented as a combination of the standalone hardware and software executed on processor 160.

In some embodiments, computer-assisted system 100 can be found in an operating room and/or an interventional suite. And although computer-assisted system 100 includes only one computer-assisted device 110 with two repositionable structures 120 and corresponding instruments 130, one of ordinary skill would understand that computer-assisted system 100 can include any number of computer-assisted devices with repositionable structures and/or instruments of similar and/or different in design from computer-assisted device 110. In some examples, each of the computer-assisted devices can include fewer or more repositionable structures and/or instruments.

In some embodiments, the imaging data can be received by the control unit 150 from an imaging device supported by a repositionable structure 120 of another computer-assisted device different from the computer-assisted device 110.

Control unit 150 can further be coupled to an operator workstation 190 via the interface. Operator workstation 190 can be used by an operator, such as a surgeon, to control the movement and/or operation of the repositionable structures 120 and the instruments 130. To support operation of the repositionable structures 120 and the end effectors, operator workstation 190 includes a display system 192 for displaying images of at least portions of one or more of the repositionable structures 120 and/or instruments 130. For example, display system 192 can be used when it is impractical and/or impossible for the operator to see the repositionable structures 120 and/or the instruments 130 as they are being used. In some embodiments, display system 192 displays a video image from a video capturing device, such as an endoscope, which is controlled by one of the repositionable structures 120, or a third articulated arm (not shown). In at least one embodiment, display system 192 provides real-time information about force and/or torque limits to the operator.

Operator workstation 190 includes a console workspace with one or more input controls 195 (sometimes referred to as master controls 195) that can be used for operating the device 110, the repositionable structures 120, and/or the end effectors mounted on the repositionable structures 120. Each of the input controls 195 can be coupled to the distal end of their own repositionable structures so that movements of the input controls 195 are detected by the operator workstation 190 and communicated to control unit 150. To provide improved ergonomics, the console workspace can also include one or more rests, such as an arm rest 197 on which operators can rest their arms while manipulating the input controls 195. In some examples, the display system 192 and the input controls 195 can be used by the operator to teleoperate the repositionable structures 120 and/or the end effectors mounted on the repositionable structures 120. In some embodiments, operator workstation 190 further includes one or more levers, pedals, switches, keys, knobs, triggers, and/or the like. In some embodiments, device 110, operator workstation 190, and control unit 150 can correspond to a da Vinci® Surgical System commercialized by Intuitive Surgical, Inc. of Sunnyvale, California.

In some embodiments, other configurations and/or architectures can be used with computer-assisted system 100. In some examples, control unit 150 can be included as part of operator workstation 190 and/or device 110. In some embodiments, computer-assisted system 100 can be found in an operating room and/or an interventional suite. And although computer-assisted system 100 includes only one device 110 with two repositionable structures 120, one of ordinary skill would understand that computer-assisted system 100 can include any number of devices with repositionable structures and/or end effectors of similar and/or different design from device 110. In some examples, each of the devices can include fewer or more repositionable structures 120 and/or end effectors. Additionally, there can be additional workstations 190 to control additional arms that can be attached to device 110. Additionally, in some embodiments, workstation 190 can have controls for controlling a platform, such as a surgical table (not shown).

One drawback of conventional methods for controlling instruments 130 is that conventional methods are often rigid and lack responsiveness to the complex and dynamic nature of various procedures. Fixed force or torque settings can be inadequate or excessive for certain tasks, which can lead to an inability to perform tasks in the desired manner. The one-size-fits-all approach of conventional methods fails to consider the variable characteristics of materials encountered during a procedure, such as the delicacy of the material, the specific force required for optimal interaction with the material, and/or the like. Another drawback of conventional methods is that the visual feedback provided to the operator to ensure appropriate force application to the material could be limited. In some applications, direct visualization of the instruments 130 and interacting material can be infeasible or undesirable. For example, in medical applications involving suture tying, efficiency can be improved if the surgeon utilizes an instrument capable of applying sufficient tension but programmed not to exceed the limits for that particular suture. Similar to suture tying, in applications that utilize an intraluminal placement of a controlled instrument, the surgeon can benefit from allowing the instrument to relax to appreciate the anatomy in its native condition, as well as potentially applying less force during insertion or removal of the device. As another medical example, during a surgical procedure, a surgeon can start with a lower default force or torque limit to avoid breaking a suture but can temporarily impose a higher force or torque limit for driving the needle through tougher tissue. In another medical example, the surgeon can switch to using a higher force or torque limit to add stability when there is a need for an instrument to remain stationary during a challenging portion of a procedure, such as when enucleating a tough myoma while holding a uterine manipulator stationary.

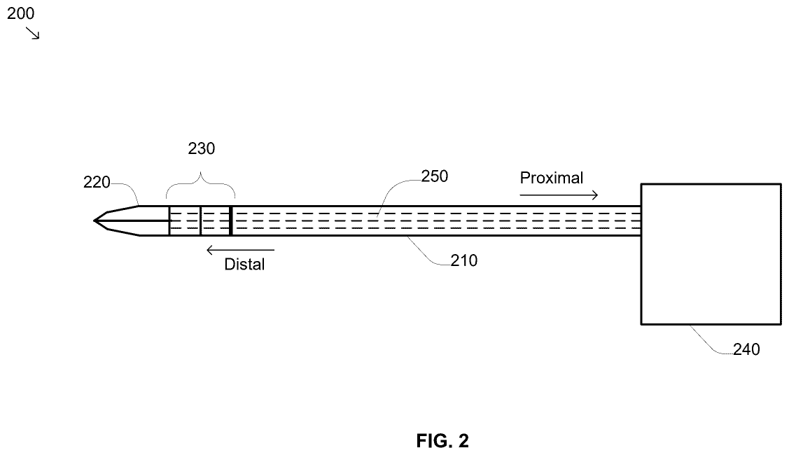

FIG. 2 is a simplified diagram showing an instrument 200 according to some embodiments. In some embodiments, instrument 200 can be consistent with any of the instruments 130 of FIG. 1. The directions “proximal” and “distal” as depicted in FIG. 2 and as used herein help describe the relative orientation and position of components of instrument 200. Distal generally refers to elements in a direction further along a kinematic chain from a base of a computer-assisted device, such as computer-assisted device 110, and/or or closest to the worksite in the intended operational use of the instrument 200. Proximal generally refers to elements in a direction closer along a kinematic chain toward the base of the computer-assisted device and/or one of the repositionable structures of the computer-assisted device.

As shown in FIG. 2, instrument 200 includes, without limitation, a long shaft 210 used to couple an end effector 220, located at a distal end of shaft 210, to where the instrument 200 is mounted to a repositionable structure 120 and/or a computer-assisted device at a proximal end of shaft 210. Depending upon the particular procedure for which the instrument 200 is being used, shaft 210 can be inserted through an opening (e.g., an access port, a body wall incision, a natural orifice, a cannula, a guide tube, and/or the like) in order to place end effector 220 in proximity to a worksite of interest located within a work area and/or an object of interest. As further shown in FIG. 2, end effector 220 is generally consistent with a two-jawed gripper-style end effector, which in some embodiments can further include a cutting mechanism, a fusing or sealing mechanism, and/or the like. However, one of ordinary skill would understand that different instruments 200 with different end effectors 220 are possible and can be consistent with the embodiments of instrument 200 as described elsewhere herein.

An instrument, such as instrument 200 with end effector 220 typically relies on multiple degrees of freedom (DOFs) during its operation. Depending upon the configuration of instrument 200 and the repositionable structure 120 and/or computer-assisted device to which instrument 200 is mounted, various DOFs that can be used to position, orient, and/or operate end effector 220 are possible. In some examples, shaft 210 can be inserted in a distal direction and/or retreated in a proximal direction to provide an insertion DOF that can be used to control how deep within a worksite that end effector 220 is placed. In some examples, shaft 210 can be able to rotate about its longitudinal axis to provide a roll DOF that can be used to rotate end effector 220. In some examples, additional flexibility in the position and/or orientation of end effector 220 can be provided by an articulated wrist 230 that is used to couple the end effector 220 to the distal end of shaft 210. In some examples, articulated wrist 230 can include one or more rotational joints, such as one or more roll, pitch or yaw joints that can provide one or more “roll,” “pitch,” and “yaw” DOF(s), respectively, that can be used to control an orientation of end effector 220 relative to the longitudinal axis of shaft 210. In some examples, the one or more rotational joints can include a pitch and a yaw joint; a roll, a pitch, and a yaw joint, a roll, a pitch, and a roll joint; and/or the like. In some examples, end effector 220 can further include a grasp DOF used to control the opening, closing, and the torque applied by the jaws of end effector 220.

Instrument 200 further includes a drive system 240 located at the proximal end of shaft 210. Drive system 240 includes one or more components for introducing forces and/or torques to instrument 200 that can be used to manipulate the various DOFs supported by instrument 200. In some examples, drive system 240 can include one or more motors, solenoids, servos, active actuators, hydraulic actuators, pneumatic actuators, and/or the like that are operated based on signals received from a control unit, such as control unit 150 of FIG. 1. In some examples, the signals can include one or more currents, voltages, pulse-width modulated wave forms, and/or the like. In some examples, drive system 240 can include one or more shafts, gears, pulleys, rods, bands, and/or the like which can be coupled to corresponding motors, solenoids, servos, active actuators, hydraulics, pneumatics, and/or the like that are part of a repositionable structure, such as any of the repositionable structures 120, to which instrument 200 is mounted. In some examples, the one or more drive inputs, such as shafts, gears, pulleys, rods, bands, and/or the like, can be used to receive forces and/or torques from the motors, solenoids, servos, active actuators, hydraulics, pneumatics, and/or the like and apply those forces and/or torques to adjust the various DOFs of instrument 200.

In some embodiments, the forces and/or torques generated by and/or received by drive system 240 can be transferred from drive system 240 and along shaft 210 to the various joints and/or elements of instrument 200 located distal to drive system 240 using one or more drive mechanisms 250. In some examples, the one or more drive mechanisms 250 can include one or more gears, levers, pulleys, cables, rods, bands, and/or the like. In some examples, shaft 210 is hollow and the drive mechanisms 250 pass along the inside of shaft 210 from drive system 240 to the corresponding DOF in end effector 220 and/or articulated wrist 230. In some examples, each of the drive mechanisms 250 can be a cable disposed inside a hollow sheath or lumen in a Bowden cable like configuration. In some examples, the cable and/or the inside of the lumen can be coated with a low-friction coating such as polytetrafluoroethylene (PTFE) and/or the like. In some examples, as the proximal end of each of the cables is pulled and/or pushed inside drive system 240, such as by wrapping and/or unwrapping the cable about a capstan or shaft, the distal end of the cable moves accordingly and applies a suitable force and/or torque to adjust one of the DOFs of end effector 220, articulated wrist 230, and/or instrument 200.

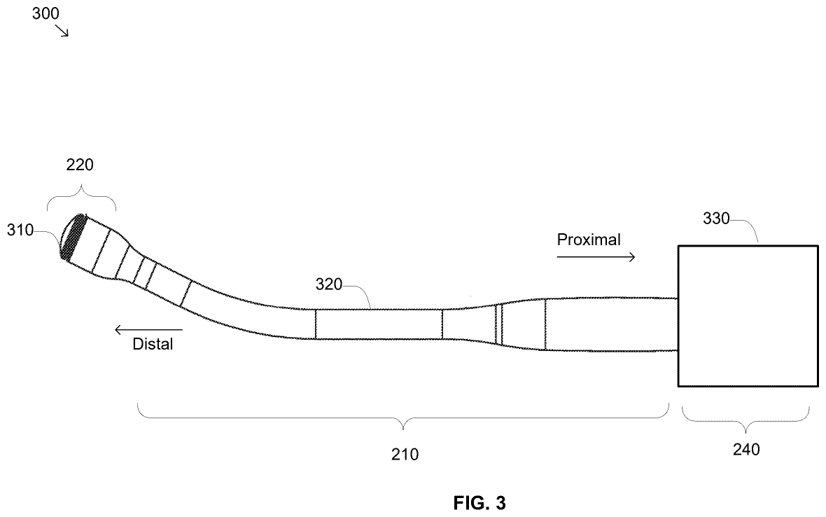

FIG. 3 illustrates an example of a circular stapler 300, according to various embodiments. As shown, circular stapler 300 includes, without limitation, an anvil and trocar assembly 310, a shaft 320, and a drive system 330. Anvil and trocar assembly 310 located at the distal end of the circular stapler 300 is an example of end effector 220 of instrument 200. Anvil and trocar assembly 310 is coupled through shaft 320 to the drive system 330 at the proximal end of circular stapler 300. The drive system 330 includes one or more inputs (not shown) that are used to extend and retract the anvil and trocar assembly 310. The anvil and trocar assembly 310 includes an anvil, which provides a surface against which the staples are formed, and the trocar, which can include a spike or can act as a spike for pushing the staples. The one or more inputs of drive system 330 are also used to fire staples and actuate a knife of staple and knife assembly sequentially, which is used for procedures involving internal stapling and material excision. When circular stapler 300 is activated by drive system 330, the spike penetrates the tissue to anchor the end effector 220 of circular stapler 300 in the correct position, ensuring precise staple formation and placement. After stapling, the spike in anvil and trocar assembly 310 is retracted as circular stapler 300 is removed from the worksite.

During medical procedures, circular stapler 300 is often introduced into the body of the patient through a lumen of an organ in order to reach the staple deployment site. During this insertion, control of the force and/or torque limits used to position and/or orient circular stapler 300 using the repositionable structure to which circular stapler 300 is mounted and/or other degrees of freedom of circular stapler 300 can be controlled to allow higher compliance with circular stapler 300. This reduces the stress and strain applied by circular stapler 300 to surrounding materials and/or tissue and increases operator confidence in the insertion. During the deployment phase of circular stapler 300, the spike is extended, and the staples are delivered into the tissue by the anvil and trocar assembly 310. Temporarily reinstating higher force and/or torque limits (first control mode) during stapling can enhance the stability of circular stapler 300, which improves the precision of the spike placement, also assists in the subsequent deployment of staples. The accurate placement of staples ensures that the worksite, such as a surgical site, is closed securely and heals properly without complications, such as leaks, tissue damage, and/or the like. Furthermore, after the staples have been deployed, the anvil and trocar assembly 310 is withdrawn from the worksite. Lower force and/or torque limits (second control mode) offer a refined touch by allowing the anvil and trocar assembly 310 to be removed with minimal force, which prevents any disturbance to the newly placed staples and reduces stress and strain to the surrounding material. In medical examples, the ability to adjust between the two control modes based on the procedure phase enhances patient safety and improves surgical outcomes.

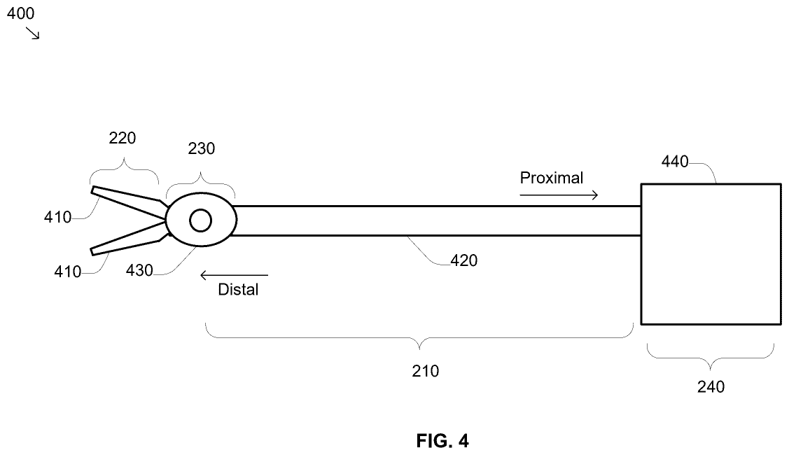

FIG. 4 illustrates an example of a needle driver 400, according to various embodiments. As shown in FIG. 4, needle driver 400 includes, without limitation, the grasping jaws 410 which is an example of end effector 220, articulated wrist 430 which is an example of articulated wrist 230, and a drive system 440 which is an example of drive system 240. In more detail, end effector 220 includes opposing grasping jaws 410 shown in an open position. Grasping jaws 410 are configured to move between open and closed positions so that end effector 220 can be used during a procedure to grasp and release a material such as a needle and/or other structures, such as sutures, located at the worksite of interest (e.g., a surgical site). In some examples, grasping jaws 410 can be operated together as a single unit with both grasping jaws 410 opening and/or closing at the same time. In some examples, grasping jaws 410 can be opened and/or closed independently so that, for example, a first grasping jaw 410 could be held steady with a second grasping jaw 410 being opened and/or closed relative to the first grasping jaw 410.

In some embodiments, operation of grasping jaws 410 and/or the joints of articulated wrist 430 can be accomplished using drive system 440. In some examples, when grasping jaws 410 are operated independently, two different portions of drive system 440 (one for each of grasping jaws 410) can be coupled to a respective grasping jaw 410 via one or more drive mechanisms in shaft 420 so that as the corresponding portion of drive system 440 applies a pull and/or a pushing force (for example, using a cable, lead screw, and/or the like) to the respective grasping jaw 410. In some examples, when grasping jaws 410 are operated together, both grasping jaws 410 can be coupled to a same portion of drive system 440. In some examples, additional portions of drive system 440 can be used to operate the roll, pitch, and/or yaw in articulated wrist 430.

Needle driver 400 can be used to handle and manipulate suture and needles to accomplish a variety of suturing tasks (e.g., needle driving, knot tying, etc.). During handheld use, the operator can adjust the relative mechanical force and/or torque applied to needle driver 400 in a given vector/degree of freedom during suturing tasks. When pulling on a suture (such as during knot tying, tightening a running suturing line, etc.), depending on factors such as the type and gauge of the suture material, the technique of applying tension with needle driver 400, and/or the like, excessive force and/or torque can be placed onto the suture resulting in undesirable damage to the suture. Applying a lower force and/or torque limit when actuating needle driver 400 can limit a load applied to one or more degrees of freedom, such as to prevent the application of tensile force greater than a published tensile strength limit for a given suture and reduce the likelihood of unintentionally breaking the suture.

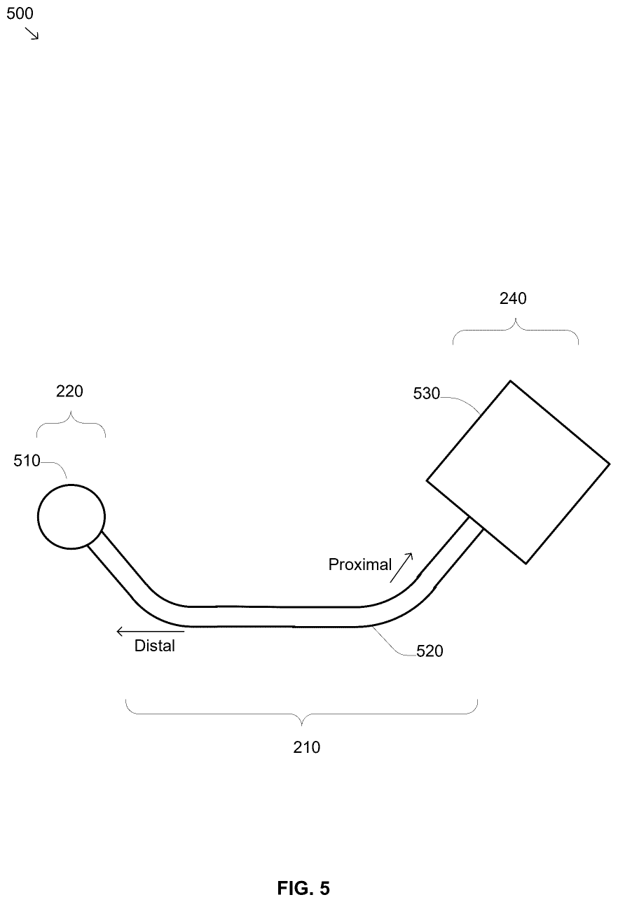

FIG. 5 illustrates an example of a uterine manipulator 500, according to various embodiments. The uterine manipulator 500 includes, without limitation, a distal end 510, which is an example of end effector 220, a curved shaft 520, which is an example of shaft 210, and a proximal end 530, corresponding to drive system 240. In some examples, proximal end 530 further includes a handle (not shown). The handle has an ergonomic grip to allow an operator to grasp and manipulate uterine manipulator 500 when not under teleoperational control. Uterine manipulator 500 further includes a curved shaft 520 having a fixed radius of curvature. Suitable materials for use in uterine manipulator should be light weight while having sufficient strength to resist substantial bending or breaking when a force is applied to uterine manipulator 500 to manipulate tissue in a patient anatomy. In some embodiments, one or more portions of uterine manipulator 500 are formed of a rigid material including metals such as stainless steel or titanium, polymers such polyetheretherketone (PEEK), ceramics, and/or the like. In some embodiments, curved shaft 520 is a solid shaft but in alternative embodiments, curved shaft 520 can be cannulated to reduce weight or to provide passage for fluid flow or other medical tools.

The distal end 510 of uterine manipulator 500 includes a tip fastener (not shown) and curved shaft 520 includes channels, grooves, fasteners and/or other mating features. The tip fastener and mating features are sized and shaped to mate with various medical accessories. Medical accessories can include a tissue probe, and/or the like. The tissue probe can be rounded, flexible, inflatable, and/or have other atraumatic tip characteristics that allow the probe to engage and apply force to tissue without tearing, abrading, or otherwise damaging the tissue. Various medical accessories suitable for use with uterine manipulator 500 are available from CooperSurgical, Inc. of Trumbull, CT and can include uterine manipulator accessories from the RUMI® and Koh product lines. When mounted to a repositionable structure using proximal end 530, uterine manipulator 500 can be controlled to pivot about a center of rotation which does not intersect uterine manipulator 500. In some examples, uterine manipulator 500 is constrained to a single rotational degree of freedom (e.g., pitch).

Uterine manipulator 500 is typically introduced into the body via the lumen of an organ (e.g., the vaginal cavity). During handheld use, the operator can adjust the relative mechanical force and/or torque applied to the instrument in a given vector and/or degree of freedom, such as yaw, pitch, and insertion. Lower force and/or torque limits allows better placement of uterine manipulator 500 that complies with the native/natural position of the tissue in the uterus to determine whether there is a need to reorient uterine manipulator 500 and/or confirm baseline orientation of uterine manipulator 500 prior to proceeding with additional portions of the procedure. Furthermore, adjusting force and/or torque limits used to position and/or orient distal end 510 of uterine manipulator 500, accommodates variations in uterine size and reduces the risk of trauma.

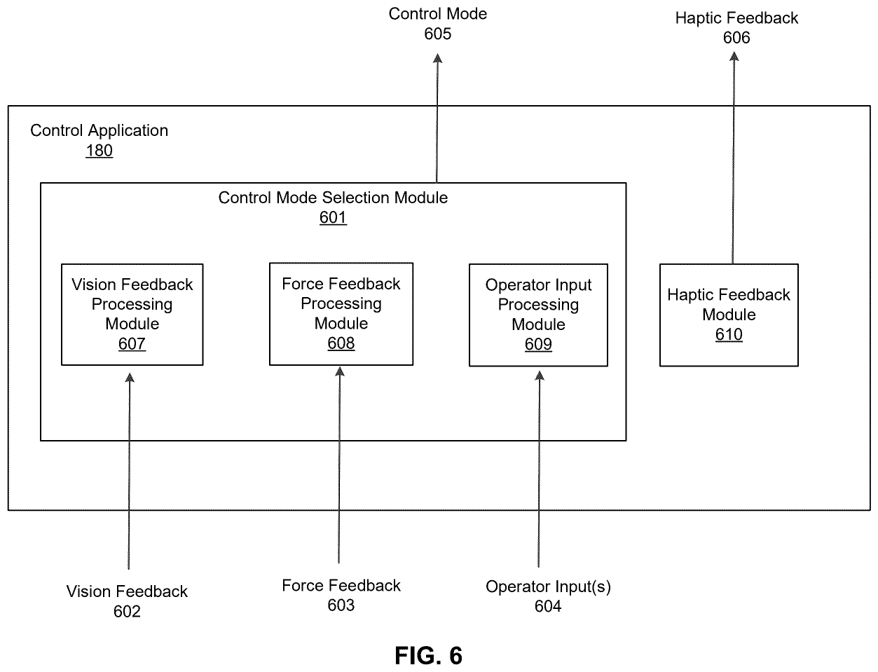

FIG. 6 illustrates the control application 180 of FIG. 1 in more detail, according to various embodiments. As shown, control application 180 includes, without limitation, a control mode selection module 601 and a haptic feedback module 610. Control mode selection module 601 includes, without limitation, a vision feedback processing module 607, a force feedback processing module 608, and an operator input processing module 609.

Control mode selection module 601 processes vision feedback 602, force feedback 603, and/or operator input(s) 604 to determine a control mode 605. Control mode selection module 601 selects control mode 605 from at least a first control mode (or first mode) 605 with default force and/or torque limits and a second control mode (or second mode) 605 with different force and/or torque limits. In some embodiments, control mode selection module prompts the operator to confirm the selected control mode 605. In various embodiments, control mode selection module 601 uses various algorithms including but not limited to artificial intelligence to learn from past events in order to determine control mode 605. For example, control mode selection module 601 can recognize patterns or sequences of events that historically determined a control mode 605 and recommends a control mode 605 during future tasks. For example, in a medical procedure, during suturing, if vision feedback 602 suggests that the needle is not following the expected path due to tissue elasticity, the control mode selection module 601 can either advise the operator to switch to a second control mode 605 or automatically switch to the second control mode 605 that offers more nuanced control of the suturing instrument, so as to improve the placement of sutures. In at least one embodiment, control mode selection module 601 includes decision trees which determine and either suggest a control mode 605 to the operator or automatically switch control mode 605 after processing vision feedback 602, force feedback 603, and/or operator input(s) 604.

In some examples, the magnitudes of the force or torque limits in the second control mode 605 are less than 50% of the magnitude force or torque limits in the first control mode 605. In various embodiments, once switched to the second control mode 605, control mode selection module 601 does not switch back to the first control mode 605 unless control mode selection module 601 detects an appropriate condition. In some examples, the condition includes a reduction in the position error, the orientation error, the force exerted, or the torque exerted that prompted the switch to the second control mode 605. In some examples, the condition includes reaching a predetermined force and/or torque limit that has been set based on the type or stage of the procedure, the type of the instrument in use (e.g. circular stapler, uterine manipulator, needle driver, and/or the like), the type material being manipulated, and/or the operator's preference. In some examples, the condition includes detecting a change in the state of the procedure, such as the deployment of a surgical spike, the initiation of staple deployment, the commencement of a biopsy, and/or the like. In some embodiments, the magnitudes of the force or torque limits in the second control mode 605 are higher than the magnitudes of the force or torque limits in the first control mode 605. For example, during a surgical procedure, a surgeon can start with a lower default force or torque limit in the first control mode 605 to avoid breaking a suture but can temporarily impose a higher force or torque limit in the second control mode 605 for driving the needle through tougher tissue. In other examples, the surgeon can switch to a second control mode 605 with higher force or torque limits to add stability when there is a need for instrument 200 to remain stationary during a challenging portion of an operation, such as enucleating a tough myoma while holding a uterine manipulator 500 stationary.

Vision feedback processing module 607 processes vision feedback 602, such as real-time image data captured by cameras and/or other imaging equipment, such as an endoscope introduced supported by one of the repositionable structures 120 and inserted in the workspace. In various embodiments, vision feedback processing module 607 uses image processing techniques, such as computer vision algorithms and/or the like, which can include edge detection, pattern recognition, machine learning techniques, and/or the like, to analyze visual cues, including but not limited to depth, texture, color, and/or motion, to provide contextual information about the environment to the control mode selection module 601. For example, in a medical procedure involving laparoscopic surgery, vision feedback processing module 607 can analyze the video feed from an endoscope to identify and track surgical instruments and tissue characteristics. When operating in the first control mode 605, vision feedback processing module 607 detects situations that warrant a switch to the second control mode, which allows for finer, more delicate maneuvers. For example, if vision feedback 602 indicates that the surgical instrument is approaching a highly vascular area, vision feedback processing module 607 informs control mode selection module 601 to switch to a mode with lower force or torque thresholds to minimize the stress or strain placed on the tissue. In some examples, vision feedback processing module 607 detects that material obscures more than a threshold amount (e.g., 50 percent, 75 percent, 90 percent, or other percent) of a distal portion of instrument 200 or the distal end of the instrument 200. In at least one example, vision feedback processing module 607 detects that the distal end of instrument 200 is located within a lumen (e.g., within a catheter, an entry guide, a hollow within the material).

Force feedback processing module 608 processes force feedback 603 and informs control mode selection module 601. Force feedback processing module 608 processes data from force and torque sensors attached to the instrument 130, the repositionable structure 120 supporting the instrument, the actuators used to drive the degrees of freedom of the instrument 130, and/or the like. In various embodiments, force feedback processing module 608 uses various signal processing algorithms, to process raw sensor data into meaningful feedback, to inform control mode selection module 601 to determine control mode 605. In at least one embodiment, force feedback processing module 608 ensures that the forces applied by the instrument 130, or the repositionable structure 120 supporting the instrument do not exceed a threshold, which is particularly important when working with delicate material. For example, during the dissection of tissue planes, force feedback processing module 608 monitors the amount of force applied by the instrument to prevent undue stress on the tissue. In another example, during procedures where different types of tissues present varying resistance-such as transitioning from soft connective tissue to denser muscular layers-force feedback processing module 608 discerns subtle changes in force feedback and suggests adjustments of the control mode 605 in real-time, suggesting a switch to second control mode 605 with lower force limits for more delicate manipulation when encountering more vulnerable tissue structures. In various embodiments, force feedback processing module 608 uses modeling techniques to predict the forces that will be encountered as a function of the trajectory and velocity of instrument 130, thus allowing for proactive determination of control mode 605 by control mode selection module 601. Predictive functionality is particularly useful, for example, in computer-assisted orthopedic surgeries, where the forces required for manipulating bone versus cartilage differ. In some examples, the threshold is determined based on one or more of a type of material (e.g., tissue) being manipulated, a type of a procedure being performed, a type of instrument, operator preference, and/or the like.

Operator input processing module 609 processes operator input(s) 604. Operator input(s) 604 include but are not limited to input controls 195 and can, for example, further include one or more levers, pedals, switches, keys, knobs, triggers, and/or the like of operator console 190. In various embodiments, operator input processing module 609 processes various movement(s) of operator input(s) 604 made by the operator and informs control mode selection module 601. For example, operator input processing module 609 can interpret increased pressure on a pedal to suggest switching to a control mode 605 with higher force and/or torque limits. In at least one embodiment, the operator can select a control mode 605 directly, which is processed by operator input processing module 609. As another example, operator input processing module 609 can detect one or more voice commands or gestures of the operator. In various embodiments, operator input processing module 609 records operator input(s) patterns for training machine learning models used in control mode selection module 601, which can be used as predictive models where the control mode selection module 601 learns to anticipate the operator's needs based on past operator input(s) 604, further refining the control modes available during various stages of a task. In at least one embodiment, the operator can adjust the force or torque limits to be used when actuating the one or more joints of the instrument 130 or the one or more joints of the repositionable structure 120 in either control modes 605. In some embodiments, operator input processing module 609 continuously monitors the position or orientation commanded by the operator input(s) 604, detecting any new positions or orientations that represent a change in the degrees of freedom-such as pressure, angle, distance, and/or the like, to adjust the operational parameters of the instrument 130 or the repositionable structure 120 supporting the instrument, specifically the force or torque limits. In some examples, operators can use grip closure on an input controls 195, such as an instrument handle, a remote control interface, and/or the like, as an input to adjust the force or torque limits. In some examples, operator input processing module 609 adjusts the force and/or torque limits in the second control mode 605 based on an orientation of the degree of freedom controlled by the joint relative to gravity. In some examples, operator input processing module 609 detects clutching of repositionable structure 120 to facilitate manual repositioning of repositionable structure 120 or instrument 130 and/or a command to retract the instrument 130 from the workspace or into a lumen of a cannula and guide tube to indicate a switch to second control mode 605.

In some embodiments, control mode selection module 601 monitors additional kinematic data associated with instrument 130 and/or the repositionable structure 120 to which instrument 130 is mounted to determine when to switch to another control mode 605. In some examples, control mode selection module 601 monitors and detects errors between the operator's intended commands (e.g., a commanded position or orientation of the instrument 130) and the actual position or orientation of instrument 130. In response to the errors exceeding a threshold, control mode selection module 601 determines to switch to the second control mode 605. In some examples, control mode selection module 601 determines whether the position and/or orientation errors exceed the thresholds for a predetermined amount of time (e.g., 0.5 s, 1 s, etc.) before determining to switch to second control mode 605. In some examples, the pre-set threshold can be adjusted based on several factors, including but not limited to the type or stage of the procedure, the specific instrument in use, the type of material being manipulated, according to the operator's preferences, and/or the like. For example, during neurosurgery, a lower threshold for errors ensures greater accuracy, while orthopedic surgeries can allow for higher thresholds due to the different nature of the tasks involved.

Haptic feedback module 610 provides the operator with haptic feedback 606 that replicates the physical sensations that would be felt if the instruments were being manipulated directly by hand. Haptic feedback module 610 is particularly useful in tasks where direct sensory feedback is lacking due to the intermediary nature of repositionable structures or teleoperated devices. Haptic feedback module 610 interprets the differences between the actual and commanded positions or orientations of the instrument 130 or the repositionable structure 120 supporting the instrument and converts the discrepancies into haptic signals, such as vibrations, resistance, and/or the like, that can be felt by the operator through the input control 195. For example, in medical procedures, the sense of touch provided by haptic feedback module 610 enhances the operator's dexterity and situational awareness. During a laparoscopic cholecystectomy, haptic feedback module 610 can give the operator a sense of the gallbladder's texture and resistance as the operator dissects the cystic duct and artery, even though the operator is not directly touching the tissues. The haptic feedback 606 helps to make the operator more aware of how much force is being applied to the tissues. In various embodiments, when a control mode switch takes place by control mode selection module 601, haptic feedback module 610 engages in a deliberate manner to alert the operator. For example, upon switching to a different control mode 605, haptic feedback module 610 can generate a haptic alert, such as a “haptic buzz” or “spike” as a distinct tactile cue that the control mode 605 has changed.

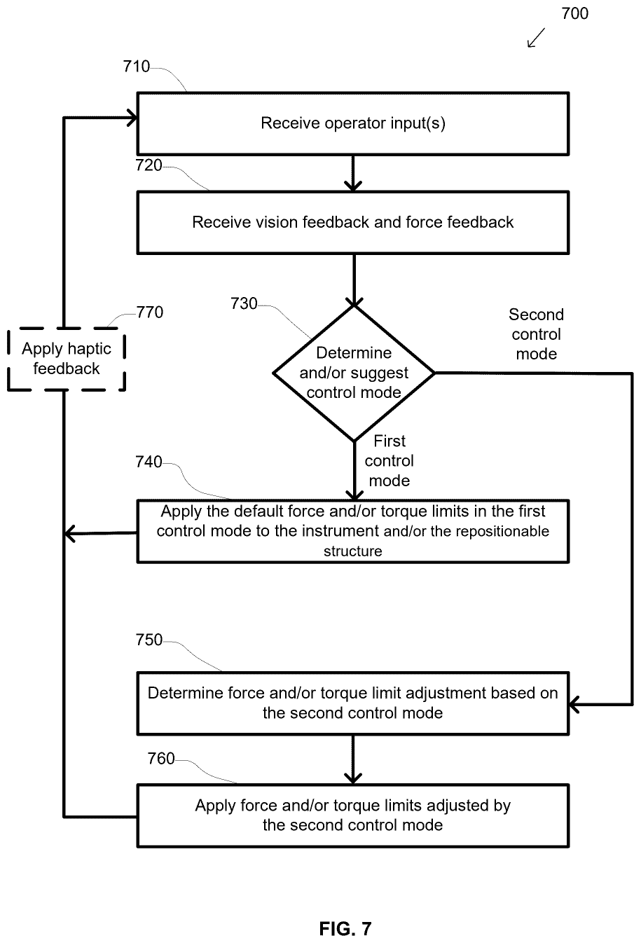

FIG. 7 is a flow diagram of method steps for controlling force and/or torque limits used when manipulating an instrument 130 or the repositionable structure 120 supporting instrument 130, according to various embodiments. Although the method steps are described in conjunction with FIGS. 1-6, persons skilled in the art will understand that any system configured to perform the method steps, in any order, falls within the scope of the present disclosure.

A method 700 begins with step 710 where operator input processing module 609 receives operator input(s) 604. Operator input(s) 604 include but are not limited to inputs made by the operator using input controls 195 and/or one or more levers, pedals, switches, keys, knobs, triggers, touch-based inputs from screens or panels of operator console 190, and/or the like. In some examples, an operator can manipulate one or more input controls 195, the one or more, levers, pedals, switches, keys, knobs, triggers, and/or the like, to teleoperate instrument 130 and/or repositionable structure 120 supporting instrument 130. Additionally, in some embodiments, operator input(s) 604 can include operator voice commands and gestures that can influence the teleoperation of instrument 130 and/or repositionable structure 120. Operator input(s) are processed by operator input processing module 609 to inform the control mode selection module 601 about the corresponding adjustments in the control mode 605, the operational parameters of the instrument 130, and/or the operational parameters of the repositionable supporting structure 120 of the instrument 130.

At step 720, vision feedback processing module 607 and force feedback processing module 608 receive vision feedback 602 and force feedback 603, respectively. Vision feedback processing module 607 processes real-time image data captured by cameras and other imaging equipment, such as an endoscope supported by one of the repositionable structures 120 and inserted in a workspace. Vision feedback processing module 607 uses image processing technologies, including but not limited to computer vision algorithms for edge detection, pattern recognition, and machine learning techniques, to analyze visual cues such as depth, texture, color, motion, and/or the like. The vision analysis provides contextual information about the environment to the control mode selection module 601, facilitating the identification and tracking of instruments 130, repositionable structure 120 supporting instrument 130, material characteristics during procedures, such as laparoscopic surgery, and/or the like.

Force feedback processing module 608 processes force feedback 603, including but not limited to data from force and torque sensors located on the instrument 130, the repositionable structure 120 supporting the instrument, and/or the actuators used to actuate instrument 130 and or repositionable structure 120. In various embodiments, force feedback processing module 608 processes the sensor data using signal processing algorithms to generate meaningful feedback for the control mode selection module 601. In at least one embodiment, force feedback processing module 608 ensures that the forces applied do not exceed safe thresholds, in particular, during delicate tasks, such as dissecting tissue planes or manipulating different types of tissues that offer varying resistance in a medical example. For example, force feedback processing module 608 can inform control mode selection module 601 to adjust the control mode 605 to a more delicate setting when transitioning from soft to denser material, preventing undue stress on vulnerable structures. In some embodiments, force feedback processing module 608 uses modeling techniques to predict the forces that will be encountered based on the trajectory and velocity of instrument 130, allowing proactive control mode adjustments by control mode selection module 601.

At step 730, control mode selection module 601 determines and/or suggests a control mode 605. Control mode selection module 601 uses the processed vision feedback 602, force feedback 603, and operator input(s) 604 to determine control model 605. Control mode selection module 601 uses various algorithms, including but not limited to artificial intelligence. Control mode selection module 601 learns from past events and determines control mode 605 based on the past events. Control mode selection module 601 recognizes patterns or sequences of events that historically led to determining a control mode 605 and recommends a control mode 605 for future tasks. In some embodiments, control mode selection module 601 uses decision trees to determine and suggest a control mode 605 to the operator or automatically initiating a switch to a control mode 605 with different force/torque limits based on the processed vision feedback 602, force feedback 603, and operator input(s) 604.

In some embodiments, control mode selection module 601 monitors additional kinematic data associated with instrument 130 and/or the repositionable structure 120 to which instrument 130 is mounted to determine when to switch to another control mode 605. In some examples, control mode selection module 601 monitors and detects errors between the operator's intended commands (e.g., a commanded position or orientation of the instrument 130) and the actual position or orientation of instrument 130. In response to the discrepancies exceeding a threshold, control mode selection module 601 determines to switch to the second control mode 605. In some examples, control mode selection module 601 determines whether the position and/or orientation errors exceed the thresholds for a predetermined amount of time before determining to switch to second control mode 605.

For example, during a medical procedure such as suturing, if vision feedback 602 indicates that the needle is deviating from the expected path due to tissue elasticity, control mode selection module 601 can determine to switch to the second control mode 605 that allows for finer control over the suturing instrument, thereby improving the placement of sutures. As another example, if vision feedback 602 indicates the instrument 130 is approaching a sensitive area, such as a highly vascular zone in a medical example, vision feedback processing module 607 can suggest switching to a control mode 605 with lower force or torque limits.

In various embodiments, once switched to the second control mode 605, control mode selection module 601 does not switch back to the first control mode 605 unless control mode selection module 601 detects an appropriate condition. In some examples, the condition includes detecting that the position error, the orientation error, or the force exerted that prompted the switch to the second control mode 605 is no longer present. In some examples, the condition includes reaching a time limit that has been set based on the type or stage of the procedure, the type of the instrument in use (e.g. circular stapler, uterine manipulator, needle driver, and/or the like), the type of material being manipulated, and/or the operator's preference. In some examples, the condition includes detecting a change in the state of the procedure, such as the deployment of a surgical spike, the initiation of staple deployment, the commencement of a biopsy, and/or the like.

After determining control mode 605, control mode selection module 601 either switches control mode 605 automatically or prompts the operator to determine whether the operator would like to switch to the determined control mode 605 before switching to the determined control mode 605. If control mode selection module 601 switches to the first control mode 605, method 700 proceeds to step 740. If control mode selection module 601 switches to the second control mode 605, method 700 proceeds to step 750.

At step 740, control application 180 applies the default force and/or torque limits in the first control mode 605 to the instrument 130 and/or the repositionable structure 120 supporting instrument. The applied force and/or torque limits are then used to limit the amount of force or torque applied by one or more actuators in the instrument 130 and/or the repositionable structure 120 supporting the instrument 130 that are used to position and/or orient the instrument 130 in response to manipulation of an input control 195 when teleoperating the instrument 130 using the input control 195. The force and/or torque limits in the first control mode 605 are typically applied for general tasks with a default set of force and torque limits. The method then proceeds to optional step 770.

At step 750, control application 180 determines force and/or torque limit adjustment based on the second control mode 605. In at least one embodiment, the second control mode 605 is designed for situations demanding higher precision or gentler manipulation, such as handling delicate materials, intricate assembly tasks, and/or the like. In some embodiments, operators can use grip closure on an input control 195, such as an instrument handle, a remote-control interface, and/or the like, as a degree of freedom to adjust the force or torque limits in the second control mode 605. In various embodiments, control application 180 allows for force or torque limits to be decreased by a specific percentage, which can be a preset value (e.g. by 50%), adjusted according to the operator's preference, or determined based on factors including but not limited to the type of instrument in use, the characteristics of the repositionable structure, the properties of the material being manipulated, or the particular demands of the procedure. In various embodiments, the magnitude of force or torque limits in the second control mode 605 can be higher than the magnitude of force or torque limits in the first control mode 605. For example, a surgeon can start with lower force or torque limits in the first control mode 605 to avoid suture breakage and switch to higher force or torque limits in the second control mode 605 for tougher tissue. The higher torque or force limits in the second control mode 605 can also enhance the stability of instrument 200, such as during enucleation of a tough myoma while holding a uterine manipulator 500 stationary.

At step 760, control application 180 applies force and/or torque limits adjusted by the second control model 605. The applied force and/or torque limits are then used to limit the amount of force or torque applied by one or more actuators in the instrument 130 and/or the repositionable structure 120 supporting the instrument 130 that are used to position and/or orient the instrument in response to manipulation of an input control 195 when teleoperating the instrument 130 using the input control 195. The method then proceeds to optional step 770.

At optional step 770, control application 180 applies haptic feedback 606. Haptic feedback module 610 provides tactile sensations to the operator, mimicking the physical feel as if directly handling the instruments 130. Haptic feedback 606 is particularly useful in examples where direct sensory feedback is absent, such as in teleoperated systems or when using repositionable structures 120. Haptic feedback module 610 calculates the discrepancies between the actual and commanded positions or forces of the instrument 130 or the repositionable structure 120 supporting the instrument, transforming the discrepancies into haptic signals, such as vibrations or resistance felt by the operator. For example, during medical procedures, such as a laparoscopic cholecystectomy, and/or the like, haptic feedback module 610 can provide the operator with a tangible sense of the gallbladder's texture and resistance during the dissection of the cystic duct and artery, enhancing dexterity and situational awareness despite the lack of direct tissue contact. Additionally, haptic feedback 606 is used to inform the operator about the application of force to material, aiding in precision and safety. In at least one embodiment, when control mode selection module 601 triggers a switch to a different control mode 605, especially one with lower force thresholds for delicate operations, haptic feedback module 610 can produce a distinctive tactile alert, such as a brief “haptic buzz” or “spike”, indicating the change in control mode 605 to the operator. The method then returns to step 710 to receive further operator input(s) 604.

As discussed above and further emphasized here, FIGS. 6 and 7 are merely examples which should not unduly limit the scope of the claims. One of ordinary skill in the art would recognize many variations, alternatives, and modifications. In some embodiments, there can be more than two control modes. In some examples, a third control mode can be activated automatically when one or more sensor(s) detect that the instrument is within a critical proximity to delicate materials, or the third control mode can be selected manually by the operator with a corresponding force and/or torque limit, allowing for a high degree of customization and sensitivity. Other variants include control modes that vary the speed of instrument movement, providing the operator with the ability to slow down instrument 130 for actions in intricate tasks, such as suturing micro-vessels or navigating around delicate structures. In at least one example, control modes can be tailored to the type of material, with force and/or torque limits for cutting, grasping, or sealing adjusted via real-time feedback from one or more sensors that evaluate the composition and resistance of materials, which can be used for manipulating instruments, such as needle driver 400, that benefit from variable force and/or torque limits based on the suture material being used, or to repositionable structures 120 that adjust movement characteristics when switching between different surgical phases such as dissection, retraction, or anastomosis. In some examples, considering the ergonomic aspects, a third control mode can be dedicated to reducing the physical strain on the operator, adjusting the force feedback on the control handles 195 to minimize fatigue during long procedures, which not only improve the operator's comfort but could also potentially enhance precision and reduce operator fatigue.

In sum, techniques are disclosed for controlling force on teleoperated instruments. The force control system includes two components, namely, a control mechanism and a feedback loop, and selects either of two control modes. The two control modes include a standard operational mode (first mode) and an enhanced force sensitivity mode (second mode) corresponding to a different compliance. Initially, the control mechanism receives input from an operator through a user interface, which dictates the desired position and/or orientation of the instrument or a repositionable structure supporting the instrument within the operational workspace. Using operator input, and considering the current control mode, the force control system adjusts the force and torque limits applied to the instrument or the repositionable structure. The feedback loop then monitors the instrument's interaction with the operational workspace using various sensors. Depending on the feedback from various sensors, the force control system can either automatically select a control mode or prompt the operator to select a control mode. Once the control mode is selected, the operator can further refine the force or torque limits using additional input controls.

At least one technical advantage of the disclosed techniques relative to the prior art is that the disclosed techniques allow for switching the force and torque limits applied to an instrument or the repositionable structure supporting the instrument, which mitigates potential complications, such as damage to sensitive materials (e.g., patient tissue in medical procedures). Another advantage of the disclosed techniques is that the disclosed techniques reduce the limitations imposed by a reliance on visual feedback alone, which is particularly beneficial in scenarios where visibility is obstructed, or visual cues are insufficient to gauge the force being applied.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-assisted system comprising;
a repositionable structure configured to support an instrument;
an input control; and;
a control system;
wherein the control system is configured to:
control the instrument based on input received from an operator using the input control, wherein controlling the instrument comprises controlling one or both of a position or an orientation of the instrument;
during the control of the instrument in a first mode, determine whether to switch control of the instrument to a second mode, wherein while in the first mode, an actuator used to control the instrument is actuated subject to a first force or torque limit;
in response to a determination to switch the control of the instrument to the second mode, switch control of the instrument to the second mode; and
while in the second mode, actuate the actuator subject to a second force or torque different than the first force or torque limit.

2. The computer-assisted system of claim 1, wherein the second force or torque limit is lower than the first force or torque limit.

3. The computer-assisted system of claim 1, wherein to determine whether to switch to control of the instrument in the second mode, the control system is configured to determine whether to switch to control of the instrument in the second mode based on one or more of vision feedback associated with the instrument, force feedback associated with the instrument, or one or more operator inputs.

4. The computer-assisted system of claim 3, wherein to determine whether to switch to control of the instrument in the second mode based on the vision feedback, the control system is configured to determine that material obscures more than a threshold amount of a distal end of the instrument.

5. The computer-assisted system of claim 3, wherein to determine whether to switch to control of the instrument in the second mode based on the force feedback, the control system is configured to determine that a force being applied by the instrument to a material is above a threshold determined based on one or more of a type of material being manipulated, a type of a procedure being performed, a type of instrument, or operator preference.

6. The computer-assisted system of claim 1, wherein determine whether to switch to control of the instrument in the second mode, the control system is configured to:
monitor the control of the instrument; and
determine whether to switch to control of the instrument to the second mode based on the monitoring.

7. The computer-assisted system of claim 6, wherein to determine whether to switch to control of the instrument to the second mode based on the monitoring, the control system is configured to detect that an error between a commanded position or orientation of the instrument and an actual position or orientation of the instrument is above a threshold for a predetermined amount of time.

8. The computer-assisted system of claim 1, wherein to determine whether to switch to control of the instrument in the second mode, the control system is configured to recognize a pattern or sequence of events that have been previously used to indicate a switch to control of the instrument in the second mode.

9. The computer-assisted system of claim 1, wherein the control system is further configured to apply haptic feedback to the input control based on a difference between actual and commanded positions or actual and commanded orientations of the instrument or the repositionable structure.

10. The computer-assisted system of claim 1, wherein the control system is further configured to:
detect a new position of a degree of freedom of the input control; and
set the second force or torque limit based on the new position of the degree of freedom.

11. The computer-assisted system of claim 1, wherein motion of the instrument is more compliant in the second mode than in the first mode.

12. A method for controlling an instrument, the method comprising:
controlling, by a control system, an instrument supported by a repositionable structure based on input received from an operator using an input control, wherein controlling the instrument comprises controlling one or both of a position or an orientation of the instrument;
during the controlling of the instrument in a first mode, determining, by the control system, whether to switch to controlling the instrument to a second mode, wherein while in the first mode, an actuator used to control the instrument is actuated subject to a first force or torque limit;
in response to determining to switch the controlling of the instrument in the second mode, switching, by the control system, controlling of the instrument in the second mode; and
while in the second mode, actuating, by the control system, the actuator subject to a second force or torque limit different than the first force or torque limit.

13. The method of claim 12, wherein the second force or torque limit is lower than the first force or torque limit.

14. The method of claim 12, wherein determining whether to switch to controlling of the instrument in the second mode comprises determining whether to switch to controlling of the instrument in the second mode based on one or more of vision feedback associated with the instrument, force feedback associated with the instrument, or one or more operator inputs.

15. The method of claim 14, wherein determining whether to switch to controlling of the instrument in the second mode based on the vision feedback comprises determining that material obscures more than a threshold amount of a distal end of the instrument.

16. The method of claim 14, wherein determining whether to switch to controlling of the instrument in the second mode based on the force feedback comprises determining that a force being applied by the instrument to a material is above a threshold determined based on one or more of a type of material being manipulated, a type of a procedure being performed, a type of instrument, or operator preference.

17. The method of claim 12, wherein motion of the instrument is more compliant in the second mode than in the first mode.

18. One or more non-transitory computer-readable media storing instructions that, when executed by one or more processors, cause the one or more processors to perform a method comprising:
controlling an instrument supported by a repositionable structure based on input received from an operator using an input control, wherein controlling the instrument comprises controlling one or both of a position or an orientation of the instrument;
during the controlling of the instrument in a first mode, determining whether to switch to controlling the instrument to a second mode, wherein while in the first mode, an actuator used to control the instrument is actuated subject to a first force or torque limit;
in response to determining to switch the controlling of the instrument in the second mode, switching controlling of the instrument in the second mode; and
while in the second mode, actuating the actuator subject to a second force or torque limit different than the first force or torque limit.

19. The one or more non-transitory computer-readable media of claim 18, wherein determining whether to switch to controlling of the instrument in the second mode comprises determining whether to switch to controlling of the instrument in the second mode based on one or more of vision feedback associated with the instrument, force feedback associated with the instrument, or one or more operator inputs.

20. The one or more non-transitory computer-readable media of claim 18, wherein motion of the instrument is more compliant in the second mode than in the first mode.
